(19) United States
(12) Patent Application Publication
(10) Pub. No.: US 2025/0342499 A1
(43) Pub. Date: Nov. 6, 2025

(54) METHOD AND APPARATUS FOR PROVIDING ZERO BOUNCE DIGITAL ADVERTISEMENTS

(71) Applicant: AdAdapted, Inc., Ann Arbor, MI (US)

(72) Inventors: Michael PEDERSEN, Ann Arbor, MI (US); Benjamin Robert RIGGLEMAN, Ann Arbor, MI (US); Jeramy Robert USHER, Dexter, MI (US)

(21) Appl. No.: 19/195,202

(22) Filed: Apr. 30, 2025

Related U.S. Application Data
(60) Provisional application No. 63/641,279, filed on May 1, 2024.

(51) Int. Cl. G06Q 30/0251; G06Q 30/0601

(52) U.S. Cl. CPC G06Q 30/0253; G06Q 30/0633

(57) ABSTRACT

In embodiments of the invention, when a shopper (or user) is presented with a digital advertisement, the shopper can choose to save the contents of the ad displayed directly to a specific retailer's digital cart and/or checkout process to recall those contents at a later time and make a purchase of the contents saved in the retailer's checkout process. Once a shopper interacts with the digital advertisement, the contents are saved directly to the retailer, without forcing the consumer out of the current experience, while updating the content of the ad once the product or content have been successfully saved to the retailer's cart. The updated contents of the ad can include additional opportunities for promotion content. The shopper is then able to visit the retailer's cart either online or in-store to complete the purchase of the advertised product or products.

### CROSS-REFERENCE TO RELATED APPLICATION

This application claims priority to U.S. Provisional Application No. 63/641,279, titled “METHOD AND APPARATUS FOR PROVIDING ZERO BOUNCE DIGITAL ADVERTISEMENTS” and filed on May 1, 2024, which is incorporated by reference herein in its entirety by this reference thereto.

### FIELD

Various of the disclosed embodiments concern a method and apparatus for providing zero bounce digital advertisements.

### BACKGROUND

In the digital advertising world, shoppers (or users) are presented, often with targeting data, an ad. This ad serves two purposes:
1) Bring awareness to a product, service, or other; and
2) Allow shoppers to click or interact with the ad to learn more about the offering and potentially drive a purchase.

One challenge with consumers clicking an ad, is that this can be a disruptive experience for a consumer. The way digital ads work today is that, once a consumer clicks on an ad, the predominant process involves either:
1) Opening a new browser window or tab and directly taking a consumer to that window or tab; or
2) A popover appears over most if not all of the screen, forcing the consumer into a new experience.

Both scenarios disrupt the activity the consumer is currently involved in.

With new ways of reaching shoppers in various mediums, from desktop, mobile phones (apps, web), tv, and other connected devices, brands and retailers can advertise to shoppers in multiple ways with similar messages and product offerings. However, shoppers are not necessarily either ready to make a purchase, able to make a purchase, or have the desire to immediately make a purchase when they are interested in the advertised product.

With retailers now having online shopping carts (or baskets, bags, etc.) tied to loyalty, getting a product or service into their carts allows them to facilitate both online and offline shopping, while tracking the cart back to an advertisement.

It would be advantageous to provide shoppers with an ad experience that both skips the entire redirect process, while also saving desired products or services to cart in one action.

### SUMMARY

A zero bounce digital advertisement is a combination of a unique identifier of a shopper, a product or service to be advertised, and a known retailer where the product can be purchased by the known shopper, along with any additional metadata that describes or promotes the product or service, such as a coupon, offer, discount to buy now, related products or services available to purchase. In embodiments of the invention, when a shopper (or user) is presented with a digital advertisement the shopper can choose to save the contents of the ad displayed directly to a specific retailer's digital cart and/or checkout process (basket, bag, other) to recall those contents at a later time and make a purchase of the contents saved in the retailer's checkout process.

In embodiments of the invention, once a shopper interacts with the digital advertisement the contents are saved directly to the retailer without forcing the consumer out of the current experience (website, mobile app, tv, etc.), while updating the contents of the ad once the product has been successfully saved to the retailer's cart. The updated contents of the ad can include additional opportunities for promotion content, such as coupons, rebates, other recommended items, or limited time offers. The shopper is then able to visit the retailer's cart either online or in-store to complete the purchase of the advertised product or products, either immediately or at a later point in time.

### BRIEF DESCRIPTION OF THE DRAWINGS

One or more embodiments of the subject disclosure are illustrated by way of example and not limitation in the figures of the accompanying drawings, in which like references indicate similar elements.

FIG. 1 shows a display on a mobile device during the presentation of zero bounce advertisements according to an embodiment of the invention;

FIG. 2 is a flow diagram that shows a retailer set up procedure according to an embodiment of the invention;

FIG. 3 is a flow diagram that shows a payload set up procedure according to an embodiment of the invention;

FIG. 4 is a flow diagram that shows a user ad viewing process according to an embodiment of the invention;

FIG. 5 is a detailed flow diagram/block diagram that shows a process for providing zero bounce advertisements according to an embodiment of the invention;

FIG. 6 is a block diagram that shows a payload set up module according to an embodiment of the invention;

FIG. 7 is a block diagram that shows a click processing module according to an embodiment of the invention;

FIG. 8 is a block diagram that shows a payload processing module according to an embodiment of the invention;

FIG. 9 is a block diagram that shows a save payload module according to an embodiment of the invention;

FIG. 10 is a block diagram that shows a retailer push module according to an embodiment of the invention;

FIG. 11 is a block diagram that shows a content retrieval module according to an embodiment of the invention;

FIG. 12 is a block diagram that shows a results processing module according to an embodiment of the invention;

FIG. 13 is a block diagram that shows a creative update module according to an embodiment of the invention;

FIG. 14 shows a display of a mobile device based advertisement according to an embodiment of the invention;

FIG. 15 shows a display of a web browser based advertisement according to an embodiment of the invention;

FIG. 16 shows a display on a mobile device of an advertisement including a post interaction discount according to an embodiment of the invention;

FIG. 17 shows a display on a mobile device of an advertisement including post interaction product suggestions according to an embodiment of the invention;

FIG. 18 shows a display providing a video based advertisement according to an embodiment of the invention;

FIG. 19 shows a display providing a post advertisement click form according to an embodiment of the invention;

FIG. 20 shows a display on a mobile device providing an AR based advertisement according to an embodiment of the invention; and

FIG. 21 is a block diagram of a computer system as may be used to implement certain features of some of the embodiments.

Those skilled in the art will appreciate that the logic and process steps illustrated in the various flow diagrams discussed below may be altered in a variety of ways. For example, the order of the logic may be rearranged, sub-steps may be performed in parallel, illustrated logic may be omitted, other logic may be included, etc. One will recognize that certain steps may be consolidated into a single step and that actions represented by a single step may be alternatively represented as a collection of sub-steps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed, scrambled and/or encrypted; etc.

### DETAILED DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

### Zero Bounce Digital Advertisements

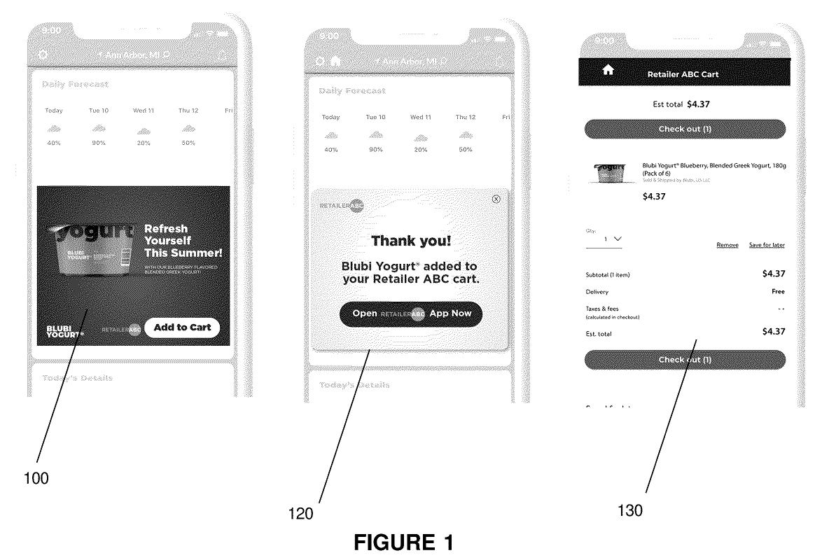

FIG. 1 shows a display on a mobile device during the presentation of zero bounce advertisements according to an embodiment of the invention. In FIG. 1, an ad 100 is presented to a user of a mobile device. Those skilled in the art will appreciate that the invention is not limited to mobile devices, but can be used with any interactive device that can present an ad to a user.

When the user interacts with the ad the content 120 of the ad is changed. In FIG. 1 when a user interacts with an ad for yogurt 100 the ad is replaced with an acknowledgement 120, i.e. “Thank you!” Significantly, the user experience outside of the ad remains unchanged; only the content of the ad itself changes. Additionally, in this example user interaction with the ad initiates an action within a retailer cart, i.e. the user is informed that “Blubi Yogurt” added to your Retailer ABC cart. “” The user can interact again with the ad, i.e. by selecting “Open . . . ” and the user s taken to the retailer's commerce site 130.

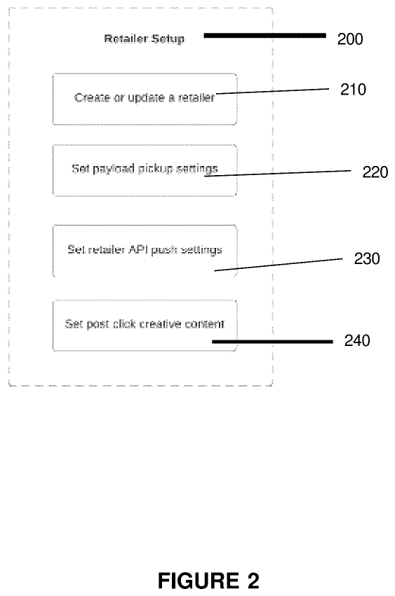

FIG. 2 is a flow diagram that shows a retailer set up procedure according to an embodiment of the invention. In FIG. 2, a retailer set up module 200 creates or updates a retailer 210. Payload pickup settings are set 220 and retailer API push settings are set 230. Post click retailer creative content is then set 240.

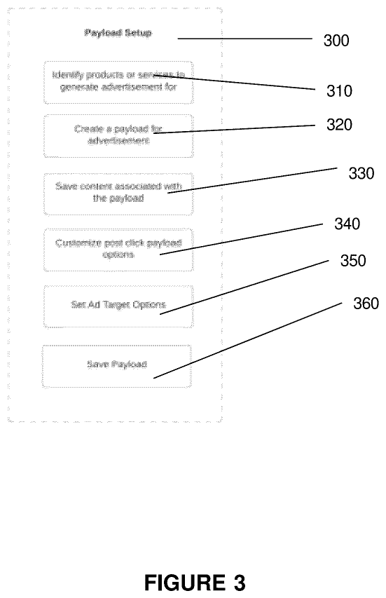

FIG. 3 is a flow diagram that shows a payload set up procedure according to an embodiment of the invention. In FIG. 3, a payload setup module 300 identifies products or services for which an advertisement is to be generated 310. A payload is created for the advertisement 320 and content associated with the payload is saved 330. Post click payload options are customized 340 and ad target options are set 350. Thereafter, the payload is saved 350.

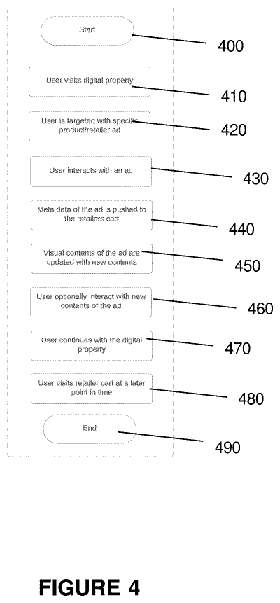

FIG. 4 is a flow diagram that shows a user ad viewing process according to an embodiment of the invention. As shown in FIG. 4, at the start of the process 400 a user visits a digital property 410 and the user is targeted or presented with a specific product/retailer digital ad 420 that contains a unique user identifier, a unique payload ID, and optional meta data.

The user views the ad.

If the user chooses to ignore the ad the process stops.

If the user interacts with an ad 430 the ad content changes to confirm the user's interaction. For purposes of the discussion herein the interaction can be a click, tap, press, button press, or any other combination of ways that a specific digital medium allows a consumer to engage with content. Upon receiving the user interaction a user identifier, payload ID, and other optional meta data are saved and sent to a click processing module. An API call is made to the payload server with the above data.

The payload is processed and saved. Thus, the payload, along with all identifying information and meta data is saved. The contents of the payload, along with identifying information, and optional meta data are sent directly to the retailer's e-commerce cart, system, or POS system 440.

Results of the save are generated and are pushed to a content processing module. The new content document is passed to the content updating module and the contents of the digital ad are updated with new content 450, e.g. text, images, call to action, etc. The user can optionally interact with the new content 460. Significantly, the user can continue to interact with the digital property without interruption 470.

At a later time, the user visits the retailer cart associated with the ad and can finish the purchase 480. This can be immediately after viewing an ad. Alternatively, the user may need to visit another website or open a specific app to access the retailer's cart. Thereafter, the process ends 490.

In embodiments of the invention, a digital ad is a combination of one or more products, a shopper, a retailer, and optional promotion, e.g. a discount or a coupon. Significantly, once the ad clicked or interacted with the shopper is not forced to leave their current experience. The foregoing information is pushed directly to a checkout experience, e.g. an online e-comm cart or in-store POS system. The ad creative can be updated post click, giving the shopper more options, such as buy now, coupons, related items to add to their shopping cart, and more.

Embodiments of the invention comprise any of the following modules (discussed in greater detail below):

An Ad Setup module which generates a unique payload identifier, which includes:
A retailer identifier;
Advertised product(s) or services; and.

Additional meta data related to the advertisement.

For an ad setup the advertiser provides the following:
A retailer where the advertised product or service can be purchased; and
A product or service to be advertised.

The product can include a SKU and/or inventory number. Additional metadata for the product or service can include:
A Quantity of items;
A coupon, discount, or promotion; and/or
Content related to the product or service, including pictures, text, and video.

With information provided by the advertiser, a unique payload identifier is generated. A payload ID created and a unique link is created, which contains the payload ID. The payload ID and results are saved in an internal database.

When a consumer interacts with an ad with containing the URL from the ad setup, metadata from the ad is passed to the click processing module. Additional metadata from the ad that is also passed to the module, data can include a timestamp, location, e.g. latitude/longitude, an IP address, and/or device information, i.e. phone type, browser, operating system, etc.

A Click Processing module which retrieves the relevant information from the ad, including:
Shopper/User ID; and or a unique identifier for the consumer
Payload ID.

The Click Processing module formats the results for further processing.

A Payload Processing module which receives results from the Click Processing module, validates the results, and provides error handling.

A Save Payload module which receives results from the Payload Processing module and saves the payload into the payload database. The payload database is used for secondary tracking and reconciliation.

A Retailer Push module which formats the contents of the ad to match the setup of a retailer's cart and/or POS system. The results of the formatting are pushed to the retailer to be ingested into their cart and/or POS system. A status message is then returned.

A Content Retrieval module which, after the contents of the ad are processed, fetches the content to replace or append the original content of the ad. Content comes from:
The results of the retailer push;
Predefined settings in the content database; or
Both.

Examples of content include:
Messaging for the shopper giving them instructions on what to do next;
Instructions on how to complete the purchase in a physical store;
An option that allows a shopper to immediately open the retailers e-commerce cart or mobile shopping app;
An incentive in the form of a coupon or rebate to entice the shopper to buy; and/or
A set of recommended products that either the advertising brand or retailer wants to promote to the shopper to encourage more purchases.

A Results processing module which receives results from the Content Retrieval Module and formats the these results to modify the new content to match the medium of the ad.

Mediums include any of:
A desktop web browser;
A mobile web browser;
Mobile app ads;
VR/AR ads; and
Video based ads.

New content is stored in a results file.

A Creative Update module which receives an updated content file from the Results Processing Module and performs the task of updating the original ad's content.

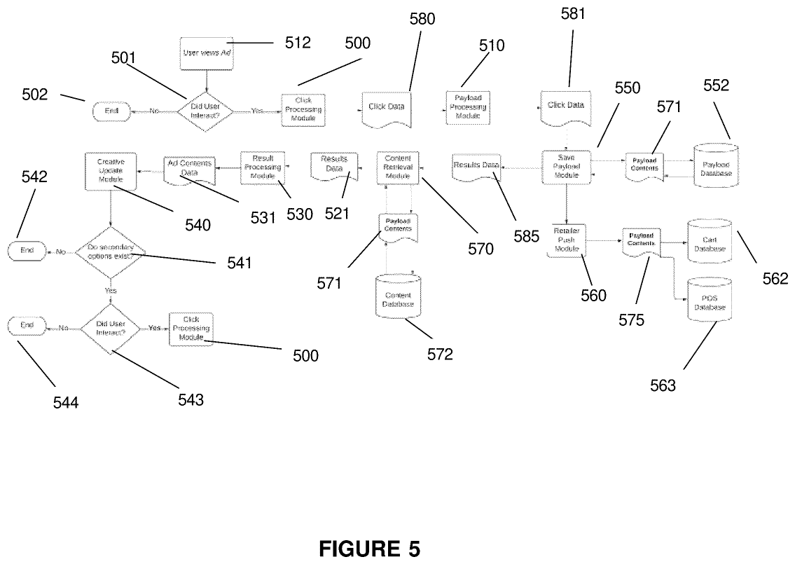

FIG. 5 is a detailed flow diagram/block diagram that shows a process for providing zero bounce advertisements according to an embodiment of the invention. In FIG. 5, the user views an ad 512 and may interact with the ad or not 501. If the user does not interact with the ad, the process ends 502; if the user does interact with the ad, the click processing module 500 is invoked which, in turn, passes click data 580 to a payload processing module 510. In turn, the payload processing module processes the payload and click data 581 is passed to a save payload module 550 and from the payload module to a retailer push module 560. The save payload module also passes payload contents 571 to a payload database 552 while the retailer push module passes payload content 575 to a cart database 562 to populate the user's interaction results in the retailer's cart for that user, and point-of-sale (POS) database 563 to initiate a transaction for a selected item form the ad on behalf of the user.

The results data 585 from the save payload module are passed to a content retrieval module 570 which retrieves payload contents 571 from a content database 572.

For further details on payload processing see U.S. Pat. No. 10,692,129, Systems and Methods for Generating and/or Modifying Electronic Shopping Lists from Digital Advertisements, issued Jun. 23, 2020, which is commonly owned by Adapted Inc., the assignee of the subject application, and which is incorporated herein in its entirety by this reference thereto, and which discloses systems and methods for generating advertisements with Add-To-List capabilities to facilitate adding products to a shopping list for a consumer who views or otherwise selects an advertisement.

The results data 521 are passed to a results processing module 530 which provides ad contents data 531 as an output to a creative update module 540. This aspect of the invention updates the ad viewed by the user without otherwise altering the user experience. A determination is made whether secondary options exist 541, e.g. a further dialog is provided to the user. If not, the process ends 542; else, a further determination is made to determine if the user interacted with the secondary options 543. If not, the process ends 544; else the click processing module is 500 is invoked.

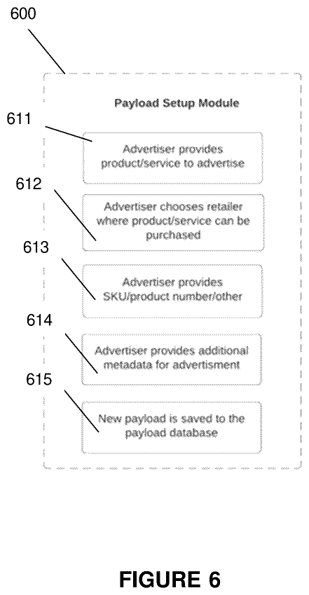

FIG. 6 is a block diagram that shows a payload set up module according to an embodiment of the invention. In FIG. 6, at the payload module 600 an advertiser provides a product/service to advertise 611. The advertiser chooses a retailer where the product/service can be purchased 612 and provides a SKU/product number/or other identifying information 613. The advertiser can also provide additional metadata for the advertisement 614. The new payload is then saved to the payload database 615.

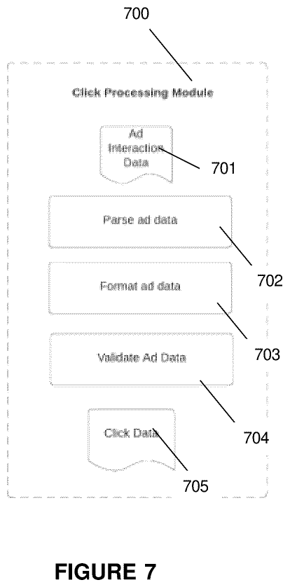

FIG. 7 is a block diagram that shows a click processing module according to an embodiment of the invention. In FIG. 7, the click processing module 700 receives the ad metadata 701 which includes the payload ID and an identifier for the consumer. The click processing module parses the metadata 702. The click processing module formats the ad 703 and builds a response data set. This data set collected is validated 704 to be accepted correctly by the payload processing module. Click data parameters 705 which comprise the data set are formatted and stored in a file to be used by other modules.

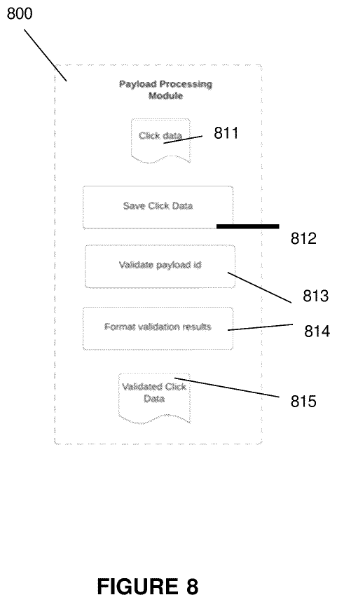

FIG. 8 is a block diagram that shows a payload processing module according to an embodiment of the invention. In FIG. 8, the payload processing module 800 takes the resulting data set from the click processing module, i.e. the click data parameters 811 and saves the results 812. The payload ID is validated 813 against an internal database where the payload ID was stored during the ad setup process. The validation results are formatted 814 and saved as validated click data 815.

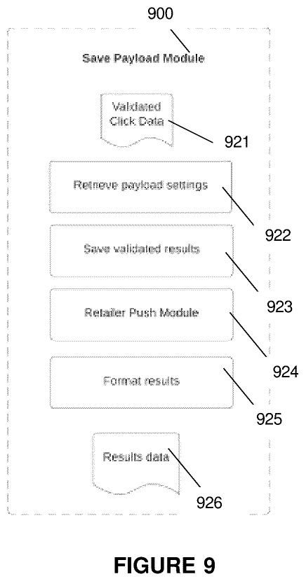

FIG. 9 is a block diagram that shows a save payload module according to an embodiment of the invention. In FIG. 9 the save payload module 900 takes the resulting data set from the payload processing module 921 and retrieves full payload settings 922 that were stored during the ad setup process. The payload data is then set to be picked-up by a retailer and saved into the payload database 923. If during the ad setup process the optional setting which allows the contents of the payload to be sent directly to a retailer's e-commerce cart/basket or a POS system is enabled, the data is then passed to the retailer push module 924. Results from both the both the saving the payload above and the retailer push module are formatted 925 into one resulting data set 926, and stored for later use in other modules.

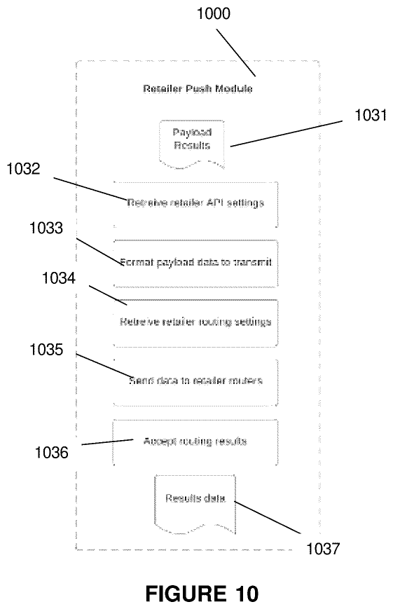

FIG. 10 is a block diagram that shows a retailer push module according to an embodiment of the invention. In FIG. 10 the retailer cart push module 1000 uses the payload result 1031. A lookup of retailer specific configurations 1032 is made from an internal database containing settings. Settings can include a retailer API endpoint/acceptance point and retailer specific data formation and mapping. Each retailer can configure how they accept data and the data is parsed and reformatted to match that formatting.

A data file is created 1033 to send to retailer's API endpoint based on the retailer's routing settings 1034 and the data is sent to retailer's endpoint 1035. The retailer can immediately reject or accept the data file 1036 and provide results from retailer's endpoint. These results can include, for example, a success/fail message and new ad content from the retailer. The retailer can then optionally send the same data to a POS endpoint if one is needed. The results data is sent back to the save payload module 1037.

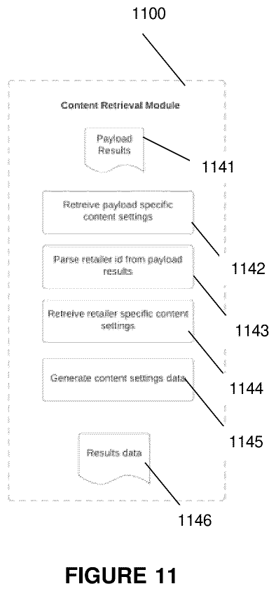

FIG. 11 is a block diagram that shows a content retrieval module according to an embodiment of the invention. Advertising brand and/or retailer are enabled by the content retrieval module which takes the results from save payload module and combines these results with other data. In FIG. 11 the content retrieval module 1100 receives the results of the save payload module 1141 and retrieves payload specific content settings 1142. The retailer ID is extracted 1143 and used to lookup any retailer specific content settings, previously setup in the retailer setup module.

The results data file is parsed 1144 and payload specific content settings are extracted. This step performs a lookup for any ad specific content updates provided by the brand. The ad specific content updates can include:
Offers, discounts, coupons;
Recommended and/or related products also to purchase; and
New display content for the ad, such as text, images, or videos.

Results of the retailer API transmission are saved in a file and sent back to the payload processing module. The results are combined into a singular data file containing all formatted results data file.

Different data points are removed from data set depending on the type of advertisement with which the user is currently interacting. This involves a decision tree that considers:
Mobile in-app ads;
Video ads;
Desktop ads;
Mobile web ads;
VR based ads;
AR based ads; and/or.
Connected TV ads.

New content is then formatted based on the decision tree and a result data file is generated based on the ad type. A resulting ad contents data file is generated 1145 and is sent to the creative update module 1146.

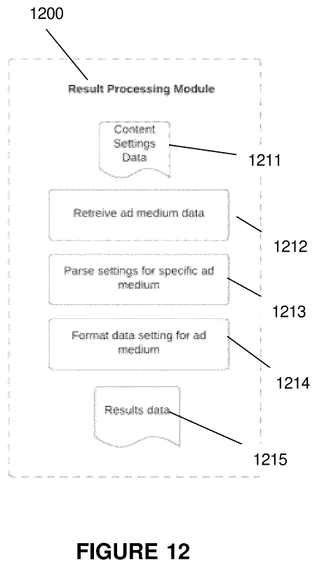

FIG. 12 is a block diagram that shows a results processing module according to an embodiment of the invention. In FIG. 12, the results processing module 1200 receives content setting data 1211 and retrieves the ad medium data 1212. Settings for the specific ad medium are parsed 1213. The data settings for the ad medium are formatted 1214. This aspect of the invention updates the ad viewed by the user without otherwise altering the user experience. The results processing module passes results data 1215 to a content retrieval module which retrieves payload contents from a content database. The results processing module also passes results to a save payload module and a retailer push module.

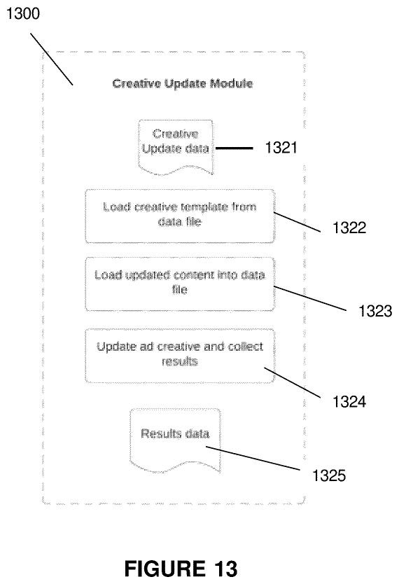

FIG. 13 is a block diagram that shows a creative update module according to an embodiment of the invention. In FIG. 213 the creative update module 1300 receives creative update data 1321 from the results processing module, loads a creative template from a data file 1322, loads the updated content into the data file 1323, and replaces content of the interacted with ad with the results to update the ad creative and collect results 1324 producing results data 1325 for use by the system. In this way, the content is updated without affecting the user experience.

### Example Use Cases

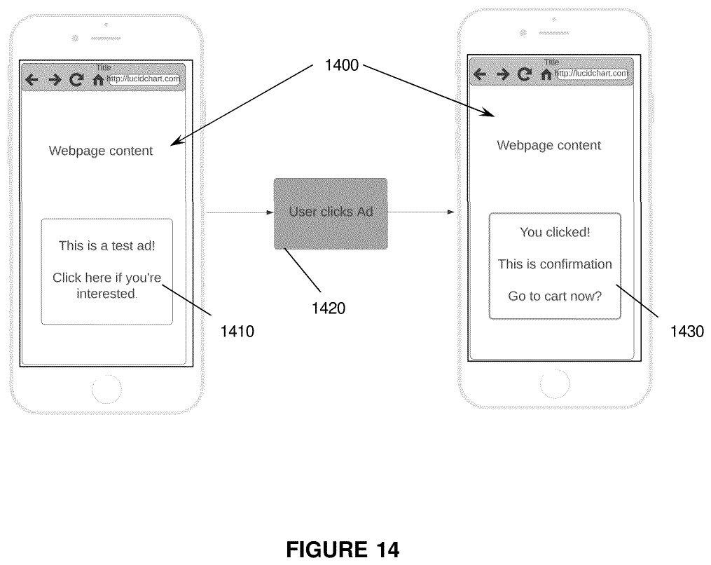

FIG. 14 shows a display of a mobile device based advertisement according to an embodiment of the invention. In FIG. 14, an ad 1410 is displayed to a user on a mobile device 1400. The user clicks the ad 1420 and the content of the ad is updated 1430 without changing the user experience on the mobile device. That is, the user remains on the same webpage. The webpage content does not change.

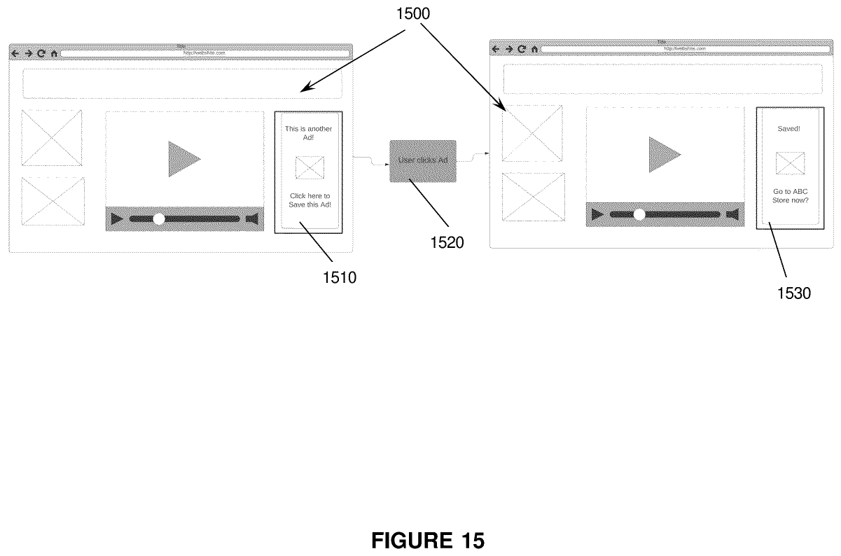

FIG. 15 shows a display of a web browser based advertisement according to an embodiment of the invention. In FIG. 15, an ad 1510 is displayed to a user on a web browser 1500. The user clicks the ad 1520 and the content of the ad is updated 1530 without changing the user experience on the web browser. That is, the user remains on the same webpage. The webpage content does not change.

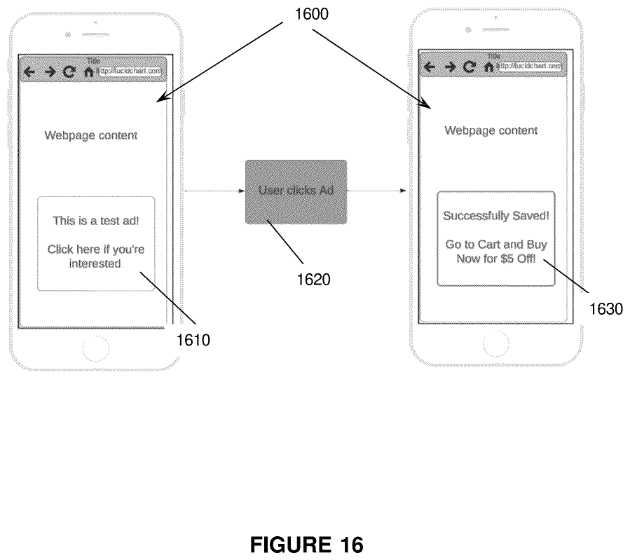

FIG. 16 shows a display on a mobile device of an advertisement including a post interaction discount according to an embodiment of the invention. In FIG. 16, an ad 1610 is displayed on a mobile device 1600. The user clicks the ad 1620 and updated content 1630 is displayed on the mobile device that offers the user a discount, e.g. “Go to Cart and Buy Now for $5 Off!”

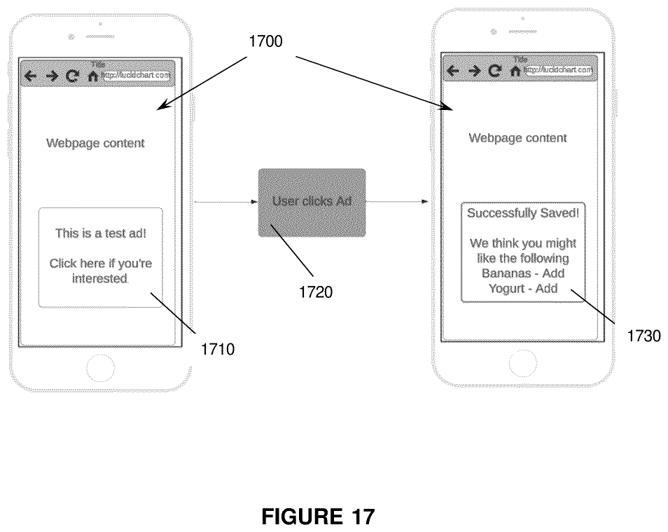

FIG. 17 shows a display on a mobile device of an advertisement including post interaction product suggestions according to an embodiment of the invention. In FIG. 17, an ad 1710 is displayed on a mobile device 1700. The user clicks the ad 1720 and updated content 1730 is displayed on the mobile device that includes post interaction product suggestions, e.g.
“We think you might like the following
Bananas—Add
Yogurt—Add”

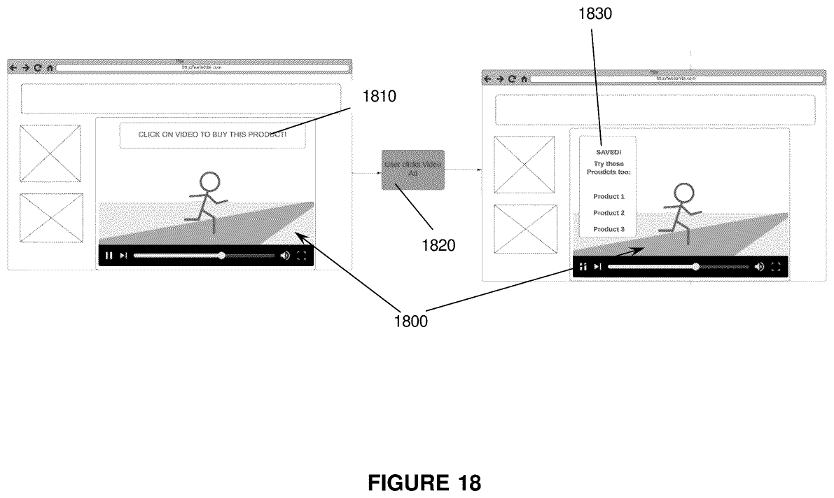

FIG. 18 shows a display providing a video based advertisement according to an embodiment of the invention. In FIG. 18, a video based ad 1810 is displayed in a video 1800. The user clicks the video ad 1820 and updated content 1830 is displayed in the video.

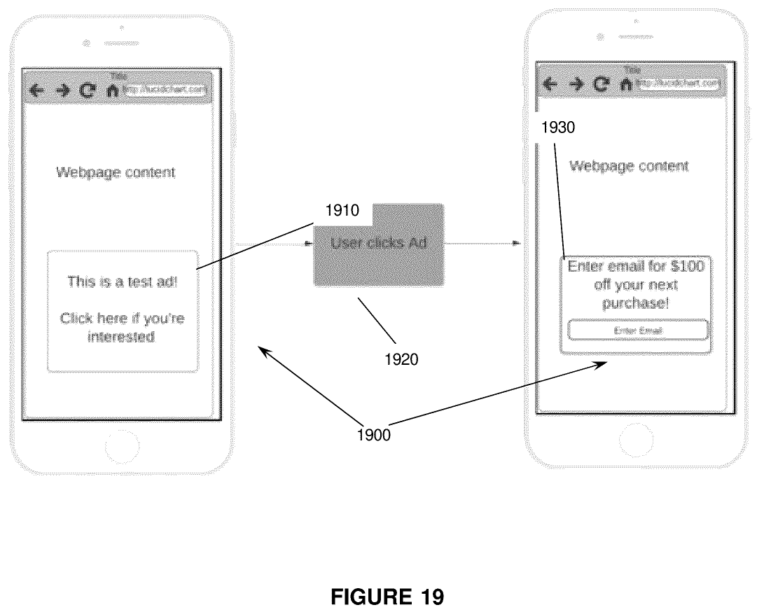

FIG. 19 shows a display providing a post advertisement click form according to an embodiment of the invention. In FIG. 19, an ad 1910 is displayed on a user device 1900. The user clicks the ad 1920 and updated content 1930 is displayed on the user device. Such updated content includes a field in which the user may enter additional information after initially clicking on the ad which, in the example of FIG. 19, is a filed in which the user may enter an email address to receive a discount off a next purchase.

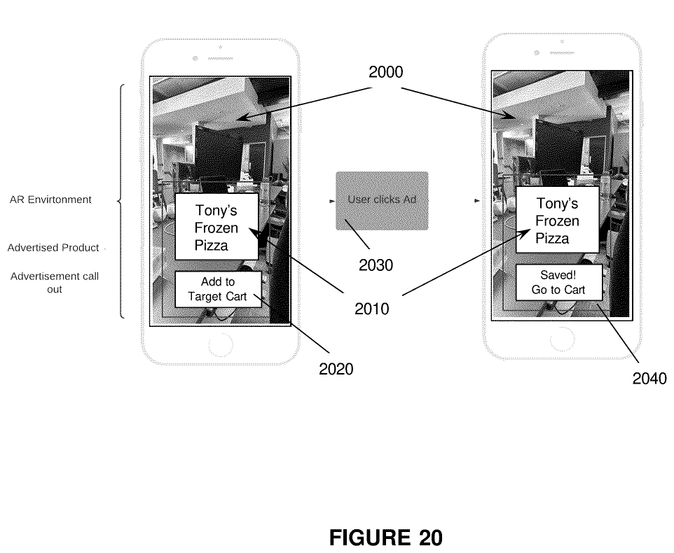

FIG. 20 shows a display on a mobile device providing an AR based advertisement according to an embodiment of the invention. In FIG. 20, an AR based advertisement for a particular product 2010 is displayed in an AR environment on a mobile device 2000. The user clicks the AR based advertisement 2030 and updated content 2040 is displayed in the AR based advertisement on the mobile device. Uniquely, the AR based advertisement shows the product, e.g. Tony's Frozen Pizza, superimposed in a store environment. An advertisement call out 2020, e.g. “Add to Target Cart” is included with the product. After the user clicks the advertisement the advertisement call out changes to reflect the change in status, e.g. “Saved! Go to Cart.”

### Computer Implementation

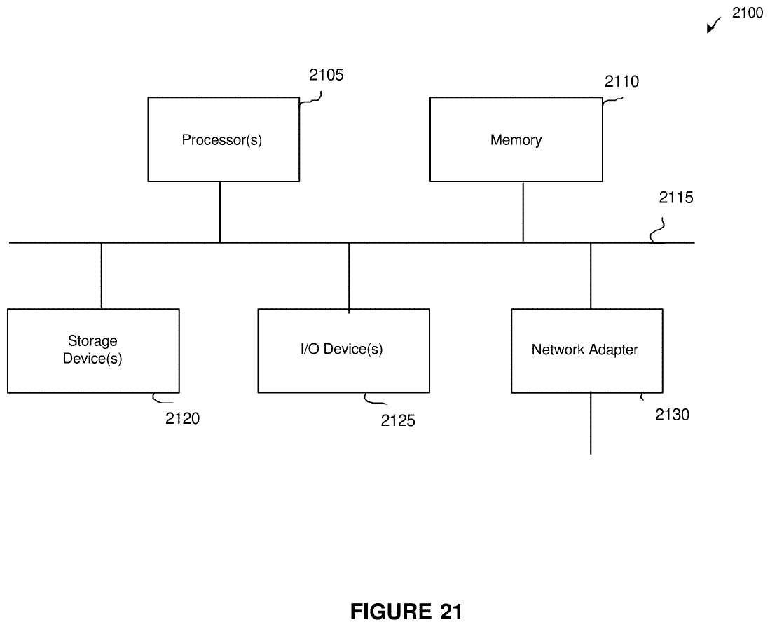

FIG. 21 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 2100 may include one or more central processing units (“processors”) 2105, memory 2110, input/output devices 2125, e.g. keyboard and pointing devices, touch devices, display devices, storage devices 2120, e.g. disk drives, and network adapters 2130, e.g. network interfaces, that are connected to an interconnect 2115. The interconnect 2115 is illustrated as an abstraction that represents any one or more separate physical buses, point to point connections, or both connected by appropriate bridges, adapters, or controllers. The interconnect 2115, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called Firewire.

The memory 2110 and storage devices 2120 are computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 2110 can be implemented as software and/or firmware to program the processor 2105 to carry out actions described above. In some embodiments, such software or firmware may be initially provided to the processing system 2100 by downloading it from a remote system through the computing system 2100, e.g. via network adapter 2130.

The various embodiments introduced herein can be implemented by, for example, programmable circuitry, e.g. one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

1. A computer implemented advertising method for presenting zero bounce digital advertisements, comprising:
presenting, on a user device, a digital advertisement including a unique payload identifier, a user identifier, and optional metadata;
receiving a user interaction with the digital advertisement, the user interaction comprising a click, tap, press, or selection;
sending the payload identifier, user identifier, and optional metadata to a click processing module;
processing the payload and user data, and transmitting data to a retailer system to initiate a transaction or pre-fill a shopping cart associated with the retailer;
updating the digital advertisement content on the user device in response to the user interaction without altering the surrounding user experience or redirecting the user to another page; and
enabling further interaction with the updated content of the advertisement while allowing the user to remain on the current digital property.

2. The method of claim 1, wherein the digital advertisement includes one or more of:
a retailer identifier, a product SKU, quantity, promotional offer, and media content.

3. The method of claim 1, further comprising:
validating the payload identifier against a payload database prior to transmitting the data to the retailer system.

4. The method of claim 1, wherein updating the digital advertisement comprises:
replacing the advertisement content with acknowledgement content, promotional messages, or additional purchase options.

5. The method of claim 1, wherein the payload is transmitted to the retailer's cart system and/or point-of-sale (POS) system through a retailer push module configured to adapt the payload to retailer-specific API requirements.

6. The method of claim 1, further comprising:
retrieving updated content from a content database based on at least one of the payload, retailer ID, advertisement type, or ad medium.

7. The method of claim 1, wherein the user device comprises a mobile device, desktop browser, connected TV, or augmented reality system.

8. The method of claim 1, wherein the user is presented with post-interaction options including:
coupons or discounts;
related product recommendations; or
a link to immediately access the retailer's e-commerce cart or shopping application.

9. The method of claim 1, wherein the digital advertisement is updated by a creative update module using a creative template and payload-specific content.

10. The method of claim 1, wherein the advertisement interaction data includes location data, device information, and a timestamp.

11. A system for providing zero bounce digital advertisements, comprising:
an ad setup module configured to generate a payload including a retailer identifier, product data, and optional metadata;
a click processing module configured to receive user interaction data and parse advertisement metadata;
a payload processing module configured to validate the payload and prepare it for saving and transmission;
a retailer push module configured to send the payload data to a retailer's shopping cart or POS system;
a content retrieval module configured to retrieve updated advertisement content based on interaction results and advertisement settings;
a results processing module configured to adapt the updated content to the format of the user's ad medium; and
a creative update module configured to dynamically update the ad displayed to the user without interrupting the user's current session or redirecting to another page.

12. The system of claim 11, wherein the payload includes a unique payload identifier linked to an internal payload database for validation and tracking.

13. The system of claim 11, wherein the click processing module formats click data including user ID, payload ID, and metadata into a structured dataset for validation.

14. The system of claim 11, wherein the retailer push module selects and formats data according to retailer-specific API endpoint configurations.

15. The system of claim 11, wherein the content retrieval module determines updated advertisement content based on ad-specific logic, content templates, and brand or retailer settings.

16. The system of claim 11, wherein the results processing module uses a decision tree to adapt updated content based on ad type including mobile, desktop, video, AR, or VR advertisements.

17. The system of claim 11, wherein the creative update module applies the updated content to the existing ad using predefined creative templates and displays the updated content inline.
